(19) United States
(12) Patent Application Publication
(10) Pub. No.: US 2007/0299979 A1
(43) Pub. Date: Dec. 27, 2007

(54) STATELESS PUBLISH/SUBSCRIBE MESSAGING USING SIP

(76) Inventors: Avshalom Houri, Netivot (IL); Gil Perzy, Holon (IL); Gili Revel, Rehovot (IL); Galina Rubinshtein, Holon (IL); Haim Schneider, Ramot Meir (IL); Ofira Tal, Rehovot (IL)

Correspondence Address: HOFFMAN, WARNICK & D'ALESSANDRO LLC, 75 STATE ST, 14TH FLOOR, ALBANY, NY, 12207, US

(21) Appl. No.: 11/426,669

(22) Filed: Jun. 27, 2006

(51) Int. Cl. G06F 15/16

(52) U.S. Cl. 709/230; 709/227

(57) ABSTRACT

The present invention discloses a system and method for stateless publish/subscribe messaging using SIP that provides SIP with similar functionality to JMS™-based publish/subscribe messaging, thereby allowing client applications that require both SIP and JMS™ messaging to be implemented using SIP only.

### BACKGROUND OF THE INVENTION

1. Field of the Invention

The present invention relates to computer-based messaging in general, and more particularly to publish/subscribe messaging of stateless information using the Session Initiation Protocol (SIP).

2. Related Art

In classic publish/subscribe messaging systems, such as those modeled by the Java™ Message Service™ (JMS™) Application Programming Interface (API), a computer-based subscriber client application subscribes to a topic, where the subscription is managed by a messaging server. A publisher application then publishes messages to the topic by sending them to the messaging server, which then sends the messages to subscriber clients that subscribed to the topic. Such topics might include, for example, basketball, with basketball articles and game scores being published to the topic and sent to its subscribers. JMS™ supports durable subscriptions where published messages are stored for a subscriber when the subscription is not active, with the stored messages being sent to the subscriber when the subscription becomes active again (i.e., the subscriber resumes the subscription).

Publish/subscribe messaging systems which use the Session Initiation Protocol (SIP) differ from classic publish/subscribe messaging systems, mainly in that in the SIP publish/subscribe model the client subscribes to the state of an entity rather than to a topic, where the state of the entity is published to and managed by a presence server. In SIP, a published event reflects a change in the state of an entity, which change is noted by the presence server. SIP does not support durable subscriptions, as past publications of an entity's previous states are not stored, an only the current state of an entity is transferred to a subscriber.

Client applications that use both JMS™ and SIP services currently require a separate engine for each. This has several drawbacks, including:

Requiring the implementation of two heavy messaging infrastructures at the server, each with its overhead of installation, administration, high availability and scalability requirements, etc.;

Requiring the client application to be implemented with two different sets of APIs and protocols;

Large client applications, which pose a problem for mobile clients with limited memory and CPU capacity; and

Duplicative authentication and authorization against both the SIP and the JMS™ servers.

### SUMMARY OF THE INVENTION

The present invention discloses a system and method for stateless publish/subscribe messaging using Session Initiation Protocol (SIP) that provides SIP with similar functionality to JMS™-based publish/subscribe messaging, thereby allowing client applications that require both SIP and JMS™ messaging to be implemented using SIP only.

A first aspect of the invention provides a system for stateless publish/subscribe messaging using Session Initiation Protocol (SIP), the system comprising: an SIP server configured to manage a subscription regarding an entity; and an SIP publisher configured to publish a message regarding said entity to said SIP server.

A second aspect of the invention provides a method for stateless publish/subscribe messaging using Session Initiation Protocol (SIP), the method comprising: receiving an SIP subscription message initiating a subscription for published messages relating to a stateless entity; receiving a published message relating to said entity; and forwarding said message to an SIP subscriber associated with said subscription without updating a state table to indicate a state of said entity.

A third aspect of the invention provides a program product stored on a computer-readable medium, which when executed, enables statelsess publish/subscribe messaging using Session Initiation Protocol (SIP), the program product comprising: program code for receiving a Session Initiation Protocol (SIP) subscription message initiating a subscription for published messages relating to a stateless entity; program code for receiving a published message relating to said entity; and program code for forwarding said message to a SIP subscriber associated with said subscription without updating a state table to indicate a state of said entity.

A fourth aspect of the invention provides a method for deploying an application for enabling stateless publish/subscribe messaging using Session Initiation Protocol (SIP), comprising: providing a computer infrastructure being operable to: receive an SIP subscription message initiating a subscription for published messages relating to a stateless entity; receive a published message relating to said entity; and forward said message to a SIP subscriber associated with said subscription without updating a state table to indicate a state of said entity.

### BRIEF DESCRIPTION OF THE DRAWINGS

The present invention will be understood and appreciated more fully from the following detailed description taken in conjunction with the appended drawings in which:

FIG. 1A, is a simplified conceptual illustration of a system for stateless publish/subscribe messaging using SIP, constructed and operative in accordance with a preferred embodiment of the present invention;

FIG. 1B is a simplified flowchart illustration of an exemplary method of operation of the system of FIG. 1A, operative in accordance with a preferred embodiment of the present invention;

FIG. 2A is a simplified flowchart illustration of a method for providing durable SIP subscriptions, operative in accordance with a preferred embodiment of the present invention; and

FIG. 2B is a simplified flowchart illustration of a method for publishing durable SIP subscriptions, operative in accordance with a preferred embodiment of the present invention.

### DETAILED DESCRIPTION

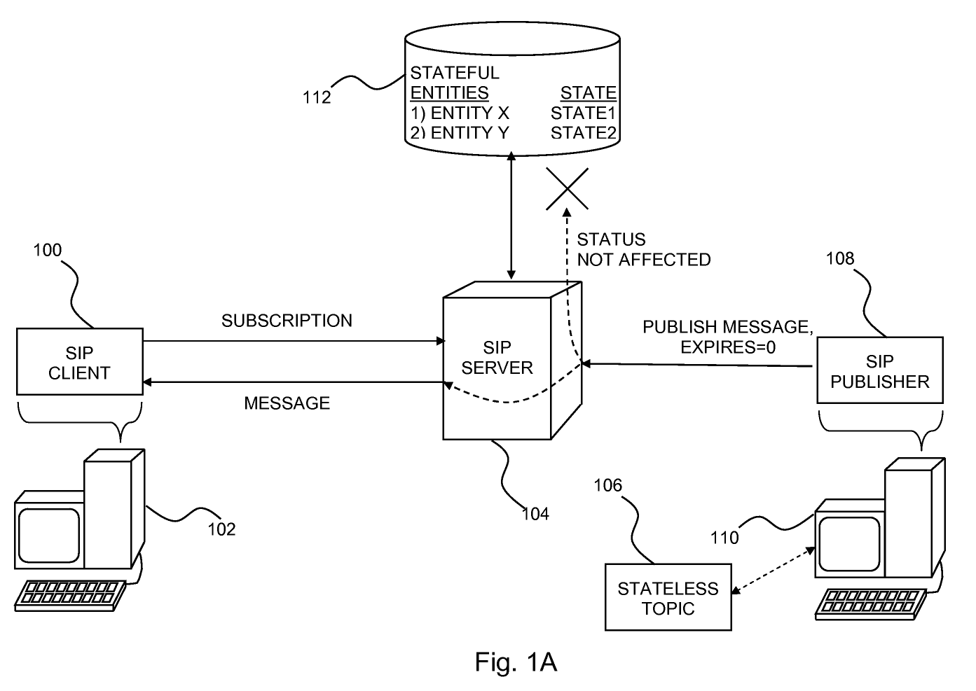

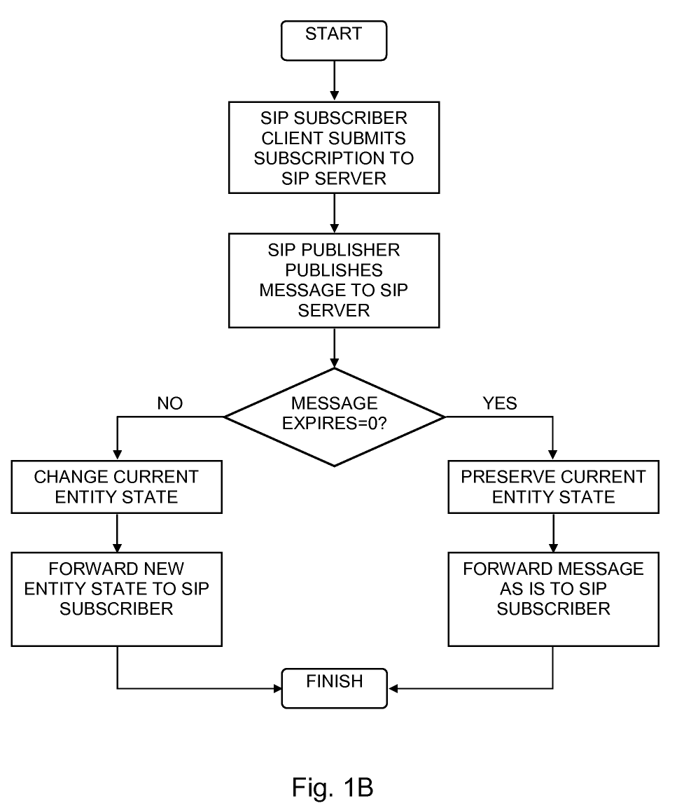

Reference is now made to FIG. 1A, which is a simplified conceptual illustration of a system for stateless publish/subscribe messaging using SIP, constructed and operative in accordance with a preferred embodiment of the present invention, and additionally to FIG. 1B, which is a simplified flowchart illustration of an exemplary method of operation of the system of FIG. 1A, operative in accordance with a preferred embodiment of the present invention. In the system and method of FIGS. 1A and 1B, an SIP subscriber client 100, such as may reside on a computing platform 102 such as a personal computer or a cellular telephone, submits a subscription to an SIP server 104, such as an SIP presence server, for information regarding an entity 106, such as a basketball news topic. In order to distinguish from the stateful SIP “presentity,” the term “entity” is used herein to indicate that SIP entities as implemented in the context of the present invention may be “stateless,” in that messages that are published for stateless entities are not intended to indicate a current entity state, and include, as such, “stateless” information. An SIP publisher 108, such as may reside on a computing platform 110 submits publications associated with entity 106 to server 104. Whereas in classic SIP applications such a subscription is for stateful information regarding the current state of an entity which is maintained by server 104 in a state table 112 (e.g., status is online, offline, busy, etc., where the entity is, for example, a cellular telephone subscriber), in accordance with the present invention the subscription may be for stateless information, such as a basketball game score published in connection with entity 106, being the basketball news topic in the present example. This may be accomplished by publisher 108 using a standard SIP PUBLISH message with the EXPIRES header field set to a predetermined value, such as zero, a non-zero value, or a value exceeding a predefined maximum value. Server 104 may in turn be configured to recognize the predetermined value of the EXPIRES header field as identifying a publication of stateless information regarding entity 106, and not including stateful information that is to be maintained as such by server 104. Server 104 thus forwards such publications to subscriber 100 without updating state table 112, as the publication is of stateless information. Alternatively, a separate header field may be used to identify the PUBLISH message as carrying stateless information, instead of using the EXPIRES field. Server 104 may then be configured to identify this field as such.

The system of FIG. 1A may be used to provide content-based subscriptions, where subscribers may define filtering criteria and receive messages that match their criteria. Content-based filtering is enabled by associating an event schema with a message. An event schema, which is sometimes referred to as a message schema, defines the type of the information contained in a message, with the system of FIG. 1A preferably supporting multiple event schemas. For example, the schema for sports news may define a news item as containing the following attributes: title, sports (e.g., basketball, football, etc.) league, teams mentioned, individual players mentioned and item body. Server 104 may support content-based subscriptions for stateless messages using standard SIP subscriptions. Subscriber 100 may submit a SIP subscription for entity 106, such as basketball news topic, and include filtering criteria such as [league=“NB36”] and [players INCLUDE “Michael Jordan”]. Server 104 preferably checks filtering criteria for messages published in connection with entity 106, forwarding only those messages that meet the criteria to subscriber 100.

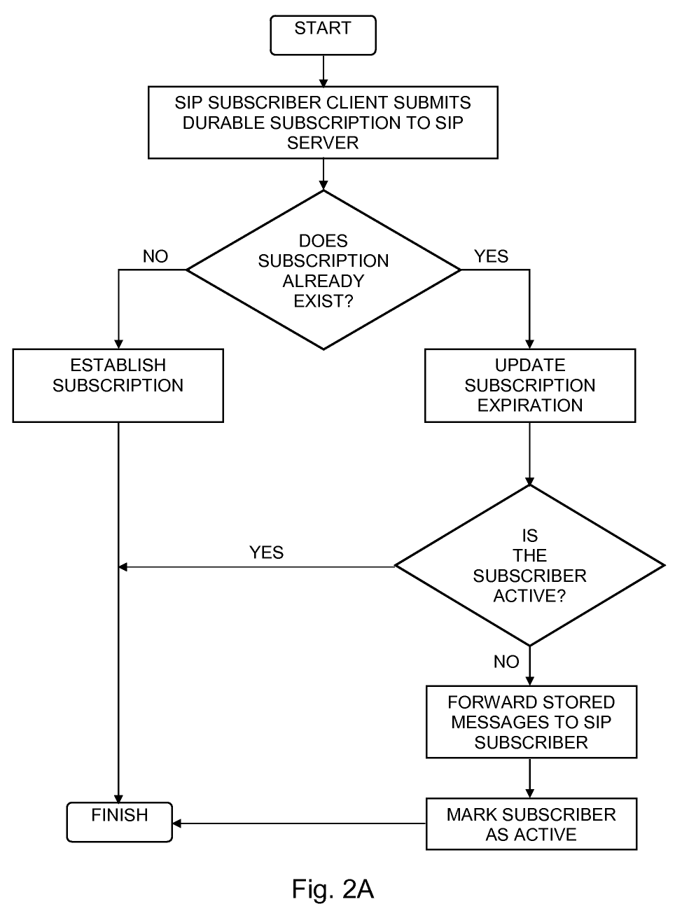

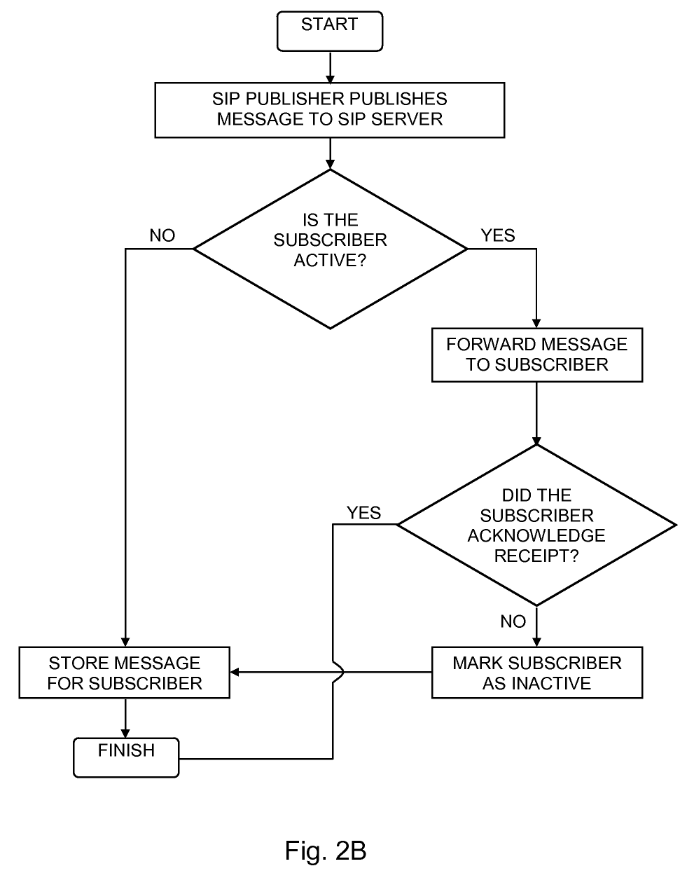

Reference is now made to FIG. 2A, which is a simplified flowchart illustration of a method for providing durable SIP subscriptions, operative in accordance with a preferred embodiment of the present invention, and additionally to FIG. 2B, which is a simplified flowchart illustration of a method for publishing for durable SIP subscriptions, operative in accordance with a preferred embodiment of the present invention. In the method of FIGS. 2A and 2B, which may be implemented by the system of FIG. 1A, support for durable subscriptions may be provided by server 104 upon receiving a request from subscriber 100 for a durable subscription. Such a request may be conveyed as part of the subscription by using a field to indicate whether or not the subscription is a durable subscription. Server 104 may in turn be configured to recognize whether or not a subscription is a durable subscription, storing published messages intended for subscriber 100 while subscriber 100 is not active, and forwarding stored messages to subscriber 100 when subscriber 100 again becomes active and resumes the subscription. Whereas in JMS™ “not active” typically refers to a connection to a JMS™ server that is severed, in accordance with the present invention a subscriber is considered to be “not active” with regard to an SIP session when the client fails to acknowledge the receipt of a NOTIFY message. Server 104 may retain the messages until subscriber 100 acknowledges receipt of the messages, or until the subscription expires. If additional messages associated with entity 106 are published while subscriber 100 is not active, server 104 preferably stores the messages and does not attempt to send the messages to subscriber 100. Subscriber 100 may again become active by resuming the subscription, such as by sending a SUBSCRIBE message for entity 106. If subscriber 100 resumes the subscription before it expires, server 104 preferably sends all the stored messages that were stored to subscriber 100. The stored messages may be sent one by one using NOTIFY messages. Preferably, only after subscriber 100 acknowledges the receipt of the NOTIFY message is the message removed from the buffer of messages waiting to be sent to subscriber 100.

Since SIP allows subscriptions to have distant expiration dates, a time limit may be placed on the life of a durable subscription, such as to avoid overflow of stored messages at server 104. For example, whereas the SIP protocol definition does not put any limit on the expiration period, server 104 may be configured to have a limit on the expiration of durable subscriptions.

It is appreciated that the present invention will allow SIP applications to implement publish/subscribe messaging for stateless events at the server while supporting durable subscriptions.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for stateless publish/subscribe messaging using Session Initiation Protocol (SIP), the system comprising:
an SIP server configured to manage a subscription regarding an entity; and
an SIP publisher configured to publish a message regarding said entity to said SIP server.

2. The system of claim 1, wherein the SIP publisher is configured to indicate to said SIP server that said message is not intended to indicate a current state of said entity.

3. The system of claim 2, wherein said SIP publisher indicates to said SIP server that said message is not intended to indicate a current state of said entity by setting a header field of said message to a predetermined value known to said SIP server to indicate that said message is a stateless message.

4. The system of claim 3, wherein said header field includes an EXPIRES header field.

5. The system of claim 1, wherein said SIP server is configured to identify said message as not indicating a current state of said entity, and forward said message to a SIP subscriber associated with said subscription.

6. The system of claim 1, wherein said SIP server is configured to forward said message without updating a state table to indicate a state of said entity.

7. The system of claim 1, wherein said SIP server is configured to forward said message only if said message matches filtering criteria associated with said subscription.

8. The system of claim 1, wherein said SIP server is configured to:
receive a subscription message initiating said subscription; and
identify said subscription message as indicating that said subscription is a durable subscription, wherein said subscription message includes a header field indicating that said subscription is a durable subscription.

9. The system of claim 8, wherein said SIP server is configured to
store published messages intended for a subscriber associated with said subscription if said subscriber is not active, and
forward said stored messages to said subscriber when said subscriber becomes active and resumes said subscription.

10. The system of claim 8, wherein said SIP server is configured to determine that a subscriber associated with said subscription is not active with regard to an SIP session if said subscriber fails to acknowledge the receipt of a message sent by said SIP server.

11. The system of claim 8, wherein said SIP server is configured to place a time limit on the life of a durable subscription.

12. A method for stateless publish/subscribe messaging using Session Initiation Protocol (SIP), the method comprising:
receiving an SIP subscription message initiating a subscription for published messages relating to a stateless entity;
receiving a published message relating to said entity; and
forwarding said message to an SIP subscriber associated with said subscription without updating a state table to indicate a state of said entity.

13. The method of claim 12, further comprising:
identifying said published message as not intended to indicate a current state of said entity via a header field of said published message being set to a predetermined value known to indicate that said published message is a stateless message.

14. The method of claim 12, wherein forwarding includes forwarding said message only if said message matches filtering criteria associated with said subscription.

15. The method of claim 12, further comprising:
identifying said subscription message as indicating that said subscription is a durable subscription via a header field of said subscription message being set to a predetermined value known to indicate that said subscription is a durable subscription.

16. The method of claim 15, further comprising:
storing published messages intended for a subscriber associated with said subscription if said subscriber is not active; and
forwarding said stored messages to said subscriber when said subscriber again becomes active and resumes said subscription.

17. The method of claim 15, further comprising:
determining that a subscriber associated with said subscription is not active with regard to an SIP session if said subscriber fails to acknowledge receipt of any of said forwarded messages.

18. The method of claim 15, further comprising:
placing a time limit on the life of a durable subscription.

19. A program product stored on a computer-readable medium, which when executed, enables statelsess publish/subscribe messaging using Session Initiation Protocol (SIP), the program product comprising:
program code for receiving a Session Initiation Protocol (SIP) subscription message initiating a subscription for published messages relating to a stateless entity;
program code for receiving a published message relating to said entity; and
program code for forwarding said message to a SIP subscriber associated with said subscription without updating a state table to indicate a state of said entity.

20. A method for deploying an application for enabling stateless publish/subscribe messaging using Session Initiation Protocol (SIP), comprising:
providing a computer infrastructure being operable to:
receive an SIP subscription message initiating a subscription for published messages relating to a stateless entity;
receive a published message relating to said entity; and
forward said message to a SIP subscriber associated with said subscription without updating a state table to indicate a state of said entity.
